(19) United States
(12) Patent Application Publication
(10) Pub. No.: US 2006/0059140 A1
(43) Pub. Date: Mar. 16, 2006

(54) Correcting data warehouse with prioritized processing for integrity and throughput

(75) Inventors: Shannon C. Noe, Round Rock, TX (US); Geoffrey A. Treitel, Austin, TX (US); Kevin L. McCloud, Austin, TX (US)

Correspondence Address: PERRY HOFFMAN & ASSOCIATES P.C., PO BOX 1649, DEERFIELD, IL, 60015, US

(73) Assignee: Logical Information Machines, Inc.

(21) Appl. No.: 11/209,582

(22) Filed: Aug. 23, 2005

Related U.S. Application Data
(60) Provisional application No. 60/609,862, filed on Sep. 14, 2004.

(51) Int. Cl. G06F 17/30

(52) U.S. Cl. 707/4

(57) ABSTRACT

Systems and methods are disclosed for acquiring various data from multiple sources that correct, format, package, and distribute data to end users. A data warehouse entity retrieves data acquired through a download interface in a format specified by the vendor, converts data into a standard or predefined data format, packages the standard format data, and distributes data to end users through a distribution interface. An incremental approach for updating data facilitates corrections to provide accurate reliable data. The data warehouse is populated with data from various vendors via a database containing data by downloading data file(s) from the individual vendor sources, parsing the data file(s) to a standard format, deleting duplicate data, and updating data if corrections or new data are identified. Newly formatted data files containing corrections and new data are exported to the location in which that vendor's data is located, checked to maintain quality, packaged into a single compressed file, tested in a test database system, and distributed to end users. The data warehouse is automated by a software application that runs jobs from a queue in operating phases. The software application and job queue prioritizes the operations and creates a controlled flow of data into and out of the data warehouse. Process operations are prioritized for integrity and throughput.

### CROSS-REFERENCE TO RELATED APPLICATION

This application claims priority pursuant to 35 USC 119(e) to U.S. Provisional Application No. 60/609,862 filed Sep. 14, 2004, which application is specifically incorporated by reference in its entirety.

### FIELD OF THE INVENTION

The present invention relates to the acquisition, the correction, the format, the package, and the distribution of various data from multiple sources to end users.

### BACKGROUND OF THE INVENTION

A data warehouse is a database designed to support decision making in an organization. It can be batch updated on a periodic basis and it can contain enormous amounts of data. The data in a data warehouse is typically historical and static.

While it may be easy to technically implement a large database, it does not make a data warehouse. A warehouse must also provide the organization and management of the data into a consistent useful entity. Once the data has been organized into a consistent standard format, a warehouse becomes useful. However, the process of populating a warehouse with data and parsing it into a standard format can be difficult because of the many types of data formats and the large amounts of data.

This is normally accomplished using an extract and transform methodology. Extraction refers to obtaining the data from individual sources such as servers. Transformation indicates processing the data to a standardized format, removing redundancies, adding business logic, filtering data, integrating additional information, etc. The data thus organized is provided for use in a computerized data retrieval system, such as applicant's assignee's U.S. Pat. No. 5,778,357 to Kolton et al. for “Market information machine” issued Jul. 7, 1998 and U.S. Pat. No. 5,414,838 to Kolton et al. for “System for extracting historical market information with condition and attributed windows” issued May 9, 1995 designed to facilitate research into the fluctuations of commodity markets and the like over time, such as fluctuations in the stock market. To this end, stock price information with economic indicator information, market average information, and other forms of market domain knowledge are advantageously combined to form a single database, or several databases accessible by the same program, providing a query language to formulate time and event limited search requests.

Although data warehousing techniques have been implemented in a variety of different ways, it is not believed that data warehousing has successfully been implemented in a manner in which the data itself becomes dynamic and correcting while still maintaining the historical nature of a traditional large data warehouse. The invention described herein addresses this deficiency of the prior art.

### SUMMARY OF THE INVENTION

The data production warehouse (data warehouse) provides the means to integrate, to store, and to distribute data separate environment. The purpose of the data warehouse is to acquire data from multiple vendors, to process the data, and to distribute the data to downstream time series databases in a computerized data retrieval system.

The data warehouse functions as an entity that retrieves and formats data for end users. Data passes through several interfaces. Data is acquired through a download interface in a vendor specified format, converted into a predefined format, packaged, and distributed to end users. By an incremental approach to updating, the data warehouse is able to correct values in order to provide accurate reliable data in point in time.

The data warehouse runs by way of a variety of operating phases. These phases run serially to each other, with a job queuing system to take pass from one phase to the next phase. The job queue prioritizes and passes the phase operations. This creates a controlled flow of data into and out of the data warehouse. By operating in this fashion, the data warehouse provides structured control of the phases for a given vendor data set and between different vendor data sets. This results in optimal performance of the database and timely delivery of data to the end users.

Briefly summarized, the present invention is directed to acquiring, correcting, formatting, packaging, and distributing data from multiple sources to end users. An incremental approach for updating facilitates correction to provide accurate reliable data. The data warehouse is populated with data from various vendors. It downloads historical data from the individual vendor sources and then parses the data to the predefined data format. It then evaluates and corrects the data by deleting duplicate data values, updating old values as corrections, and updating new values as current values. Current values are termed as historical values—meaning the current accurate value for the data point(s). It then exports the data from the database as predefined formatted data files to a defined location, checks to maintain quality, and packages the exported data to a single compressed file. The compressed file is loaded to a test in a computerized data retrieval system, and if successfully tested the file is distributed to the end user's system. The data warehouse is managed by an application that runs work jobs in serial phases from a queue. The queue prioritizes work jobs to be done and creates a controlled flow of data into and out of the data warehouse.

### BRIEF DESCRIPTION OF DRAWINGS

The invention will now be more particularly described, by way of example only, with reference to the accompanying drawings, in which:

FIG. 1 illustrates a block diagram showing the programming flow of the download phase of operation;

FIG. 2 illustrates a block diagram showing the programming flow of the process phase of operation;

FIG. 3 illustrates a block diagram showing the programming flow of the update phase of operation; and

FIG. 4 illustrates a block diagram showing the programming flow of the export, quality, package, intrapply, and distribution phases of operations.

### DETAILED DESCRIPTION OF THE PREFERRED EMBODIMENTS

The purpose of the data warehouse is to acquire data from multiple vendors, store it into a database, and distribute it to applicant's assignee's computerized data retrieval system database (herein after “the information database”) providing data collection and distribution functioning in a commercial environment computer system between multiple data vendors and end-user customers. The data warehouse implementation comprises a Java application and a relational database. The Java application is a collection of programs that allow automated and manual operation of the data warehouse functions on the relational database. Vendor specific Java programs are employed for downloading and processing of data. In general, standard Java programs are employed in the updating, packaging, testing, and distributing of data out of the data warehouse; although vendor specific Java programs are employed at times for these operations as well.

There are eight phases involved in the acquisition, storage, and distribution of data into the data warehouse. These eight phases are controlled and automated by the Java Worker application. Job messages are part of the Java Worker application. Jobs communicate to the Worker application the vendor and the phase to execute. When a Worker application is free, it pulls the next job message from a job queue. The retrieved job contains execution information for a vendor and its phase. The Worker application then executes the specific program for that vendor and phase. If the executed program's return code is successful and it is not the last phase, the Worker places a new job message back into the queue. The new job from the Worker indicates the next execution phase for the vendor data set. The Worker is then free to retrieve the next job from the queue for any vendor. If the program did not run successfully, the Worker takes an action depending on the vendor's phase.

To help illustrate the descriptions of each phase is an example vendor, the Federal Reserve Economic Data (“FRED” is a public database of over 3,000 economic indicators maintained by the Federal Reserve Bank of St. Louis). FRED illustrates the phases involved in the acquisition, storage, and distribution of data. Descriptions for each of the phases are provided herein.

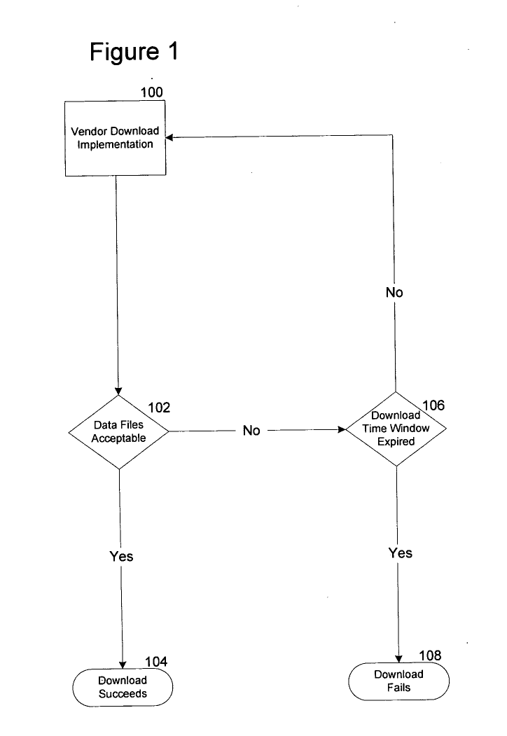

FIG. 1 is a block diagram showing the programming flow of the download phase of operation, Phase 1. The goal of the first phase is to acquire the file(s) containing the data to be processed in later phases. The download phase begins with a Worker getting a job message and executing the download code at 100. Each vendor implements a download program and the mechanism of download (ftp, http, email, or other implementation). If no transmission error is detected during the download at 102 and the data is successfully retrieved from the vendor, the download completes successfully at 104. If a transmission error is detected at 102, the Worker then checks to see if the download time window timer has expired at 106. Each vendor's download phase has a window of time in which the Worker is allowed to attempt to download. If the download time window has not expired at 106, the Worker will reattempt the download phase and rerun the vendor specific download code at 100. If the download window has expired at 106, the download phase fails at 108.

If the data file(s) are downloaded successfully, the file(s) are placed in a vendor specific source folder. The download then finishes successfully and the Worker puts a job message for the vendor's next phase into the job queue. Whether the download phase succeeds or fails, the Worker application moves to the next job in the job queue.

For example, in FRED's case, the files have predetermined names and locations. When the Worker application starts FRED's download program, it downloads the files by http and saves them to a source directory. When the source files are retrieved, FRED's download program unzips them and saves them into the source folder. Download then finishes successfully and the Worker puts a job message for FRED's next phase into the job queue.

Each data file from FRED contains data pertaining to one economic indicator. Each file starts with descriptive information such as the source of the data and the units of measure in which the data is represented (see example below). Note the “Series ID” line and the “Frequency” line as they will be used later. A series ID is similar to a Social Security number in that it uniquely refers to one entity. Series IDs are typically an abbreviated form of the economic indicator's title. The frequency is the time between values provided. The following is an example of a file with three lines of data:
Title: Manufacturers' New Orders: Nondefense Capital Goods Excluding Aircraft
Series ID: NEWORDER
Source: U.S. Department of Commerce: Census Bureau
Release: Not Applicable
Seasonal Adjustment: Seasonally Adjusted
Frequency: Monthly
Units: Millions of Dollars
Date Range: 1992-02-01 to 2005-03-01

Last Updated: 2005-05-04 10:06 AM CT

| DATE | VALUE |
|---|---|
| 1992-02-01 | 34410 |
| 1992-03-01 | 35551 |
| 1992-04-01 | 36549 |

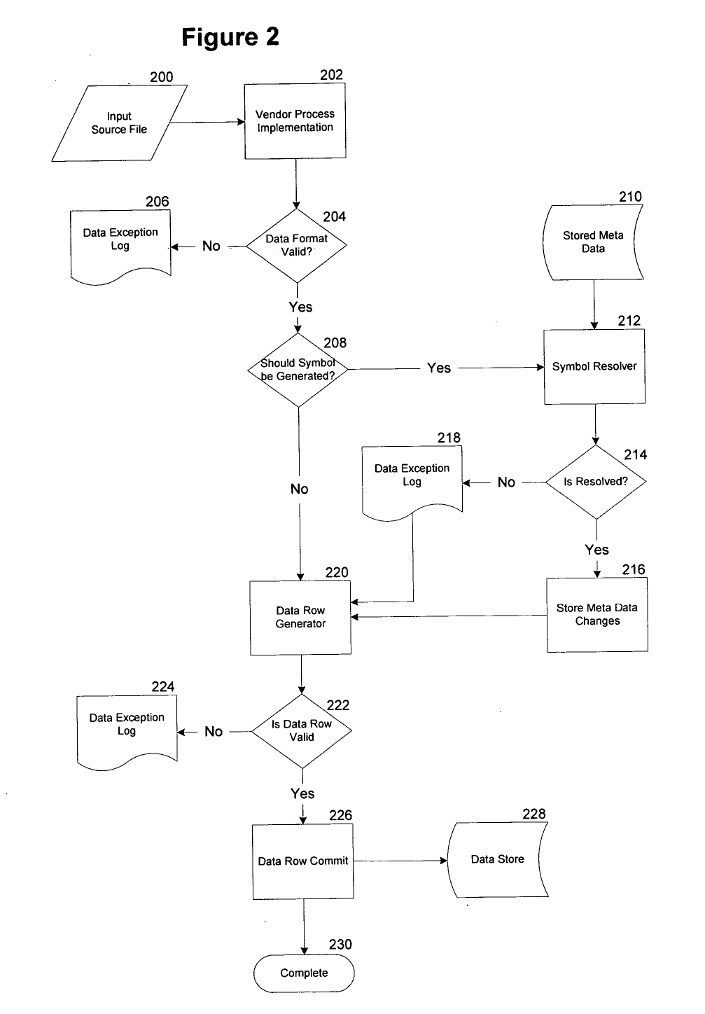

FIG. 2 is a block diagram showing the programming flow of the process phase of operation, Phase 2. The goal of the process phase is to take the data retrieved from the download phase and insert the data into the database. Here the specific vendor format is converted into the standard or predefined data warehouse format which may be defined according to a predefined convention in the industry. The converter interface includes a predefined data row format generator.

Before data processing begins, a zip file is made of all the files currently in the vendor's source directory. That zip file is moved to an archive directory. These zipped files serve as archival backups in case the data is reprocessed at a future date.

The process phase begins the parsing of the source file(s) at 200. The process program is vendor specific at 202. The program checks if the inputted data format is valid at 204. If the data format is valid, the program then checks if a vendor symbol can be generated at 208. If a symbol can be generated, a vendor symbol is created by resolving the current symbol with any stored meta-data from the vendor at 212. The meta-data changes are stored at 216 and the process phase moves on to generating data value rows from the source data to be stored at 220.

Vendors have a set of one or more data tables. These tables are named by the vendor, a group name, and either “_d” for daily values or “_m” for intraday values. Data is inserted into a table one row at a time. Rows have the following columns (note that batch ID, Quote Number, VSID, Transaction Date, Status Flag, and Cbatch ID are required for all data groups):
(1) Batch ID: This ten digit field indicates which execution batch of a vendor's Process inserted the row into the table. The first eight digits of the batch ID are the date in YYYYMMDD format. To indicate different batch runs of Process on the same day, two digits are appended at the end.
(2) Quote number: This field is used to differentiate among rows of data sharing the same batch ID.
(3) VSID—vendor symbol ID: This is a unique numerical identifier for a vendor symbol. A vendor symbol is a name for data set.
(4) Transaction date: This date is the one on which the value applies. It includes the time of day for intraday values.
(5) Value(s): The column(s) that contains the data value(s) associated with the row's VSID for the given transaction date.
(6) Status flag: This flag determines which row among those sharing a VSID and transaction date gets exported to the end users.
(7) cbatch ID: If a new row of data is a correction for an existing row, the existing row's status flag is set to ‘C’ and cbatch ID is set to the new row's batch ID. This is handled in the Update phase.

If the data row is generated correctly at 222, the source data is then stored into the table and the appropriate values are set for the non-value columns at 228.

As with the download phase, errors may arise in the process phase. A file may not be in the expected format. The vendor symbol found in a file or generated by other means may not exist in the database. Values may be missing in the file or may be incorrect (e.g. letters found where numbers were expected). If the error encountered is critical, the process code tells the Worker that it failed to finish. The Worker in turn sends an alert and proceeds to the next job. If the error encountered is manageable, the Process program continues processing and alerts with a warning. If the phase finished successfully, the Worker places a new job for the vendor and the next phase in the job queue. The Worker then grabs the next available job from the job queue.

To illustrate how the process phase functions take, for example, the FRED vendor. FRED's process program checks each line of the source data file for the words “Series”, “Frequency”, “DATE”, and “VALUE”. When either of the first two are found, the value that follows on the same line is captured by the program. When “DATE” and “VALUE” are found on the same line, the program expects for the rest of the file to contain the data to be stored in the database. The program then reads each line, storing each date and value into a data table. FRED has one table named fred_imp_d. All the rows in fred_imp_d are of the format defined by the group “imp”, which contains the same 7 columns as discussed herein however substituting the name of the value column with the name “_Implicit_” column.

If FRED's process is run for the first time on Mar. 1, 2005, then all rows in fred_imp_d will have the batch ID 2005030100. The first row inserted will have the quote number ‘0’. The second row will have ‘1’ and so on. In FRED's case, the series is the vendor symbol. The vendor symbol will be NEWORDER for data values in the example file. Every data row in the file contains a date and a value. The date is used as the transaction date and the value is stored in the “_Implicit_” column. Every row will have its status flag set to ‘P’ to indicate the processing state. All of the cbatch IDs are left null.

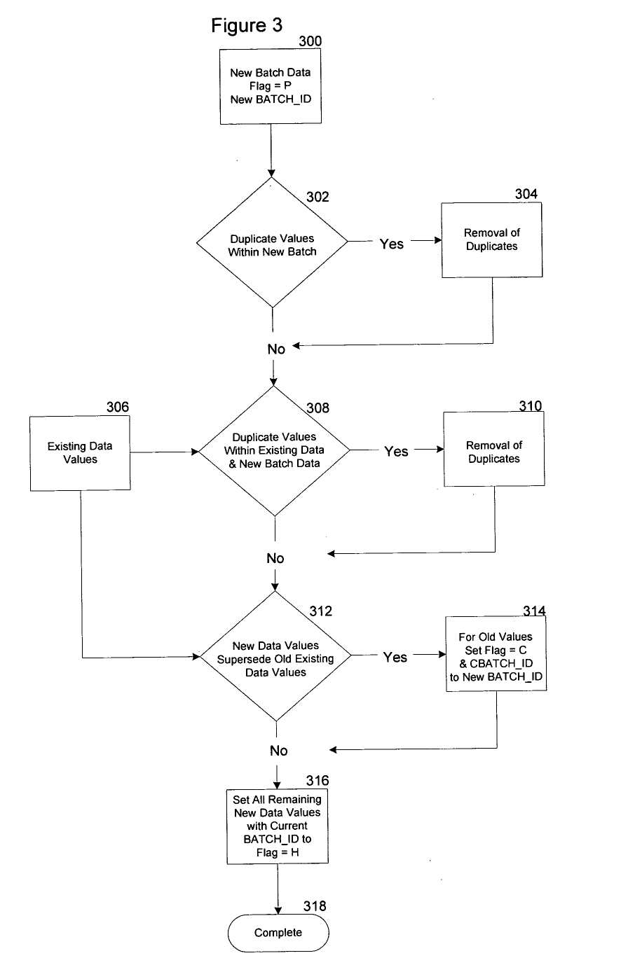

FIG. 3 is a block diagram showing the programming flow of the Update phase of operation, Phase 3. The goal of the update phase is to delete duplicate data values, identify data corrections of old values, and determine new values.

The update phase begins with a review of the new batch of data at 300. During this step the data tables are searched for rows that share the same batch ID, VSID, and transaction date at 302. When such rows are found, all are deleted except the one with the highest quote number at 304. The remaining rows' status flags remain in the initial state set to ‘P.’

Next the update phase compares the new batch of data to existing data at 308. There are three steps here: deletion of duplicate data at 310, setting old values as corrections at 314, and setting new values as the current historical value at 316. If a row shares a VSID and transaction date with an existing row from 306 and all values are equal, then it is considered a duplicate data record at 308 and deleted at 310. If a row shares a VSID and transaction date with an existing row from 306 but has at least one different value, then it is considered a correction on the old data at 312. The existing row's status flag is set to ‘C’ and its cbatch ID is set to the batch ID of the new row at 314. Finally, all remaining rows with the current batch ID have their status flags set to ‘H’ as the new accepted historical values at 316. The phase completes at 318. The Worker then puts a new job message into the job queue for the vendor's Export phase.

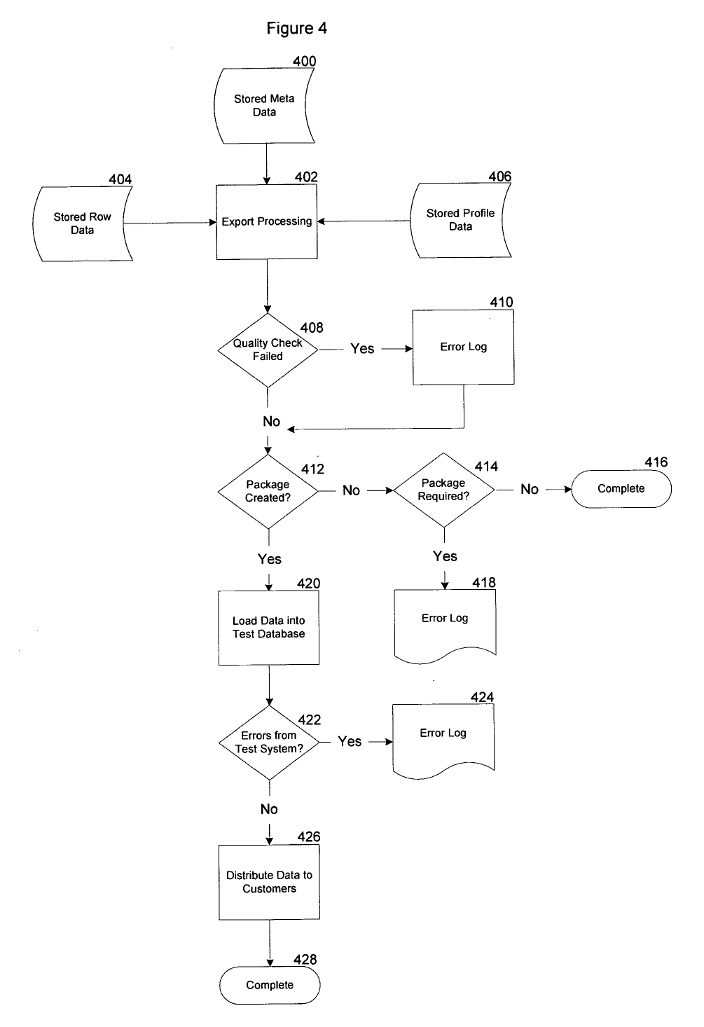

FIG. 4 is a block diagram showing the programming flow of the export phase, quality phase, package phase, test phase, and distribution phase of operations—Phases 4, 5, 6, 7, and 8. The goal of these phases is to export data from the data warehouse for distribution. “Tags” are names for sets of VSIDs and are created to filter data distributed to end users. Export extracts the vendor symbols and the data records associated with each tag to predefined formatted files in the current batch ID and current Cbatch ID. A meta-data file is also created with descriptive information pertaining to the contents of the data files at 402. The quality control interface verifies the integrity of the data structure by applying checks directed to each of the multiple vendor data sources, and the distribution interface transfers data to end-users.

Export can package values from new batches as well as create full histories of data by including all batch IDs for tag's set of vendor symbols. The information files are saved in directories named after their respective tags. These tag directories are located in directories named with a letter indicating the type of export (batch or history), the date in YYYYMMDD format, and a unique number for different runs of the export phase on the same day (e.g. “b.20050301.0”).

The Worker is notified of errors encountered in the export phase. If the phase fails, an alert is generated and the Worker does not create a new job for the vendor.

For FRED, there is a tag called “frd” that contains all of FRED's vendor symbols. When FRED's first run reaches the Export phase, it looks for batch ID 2005030100 in all rows of FRED's data tables and saves into data files the dates and values of those marked with status flag ‘H’. In later runs, corrected values would also be exported in their own format for distribution. For each vendor symbol, there is an associated information database symbol, which is the name for a type of data in the information database. The meta-data file contains descriptions for the information database symbols and where the data for those symbols is located on the information database. The files are stored in a directory named “frd”, which resides in a directory named “b.20050301.0”.

FIG. 4 is a block diagram showing the programming flow of the quality phase of operation, Phase 5. The goal of the quality phase is to search the database for incorrect values at 408. Checks can be set for certain types of data. For example, if a table contains high and low values for a stock in a single data record, then a check can be made to confirm that the low value in the table is lower than the high value. Checks can also be specific to a data source. If a vendor is known to send incorrect values, the corrections, and finally the original incorrect values, a check can be made to look at the status flags and cbatch IDs to find the changes among the vendor's data. When a check fails, an alert is generated that details the check that failed at 410. Regardless of the result of the checks, the Worker creates a new job message for the vendor as it moves to the next phase.

FIG. 4 is a block diagram showing the programming flow of the package phase of operation, Phase 6. For each tag, package compresses the meta-data file and data file(s) into a single file at 412. If a required package cannot be created, the Worker generated an alert at 418. If the packaging is successful, the Worker queues the vendor with the seventh phase.

FIG. 4 is a block diagram showing the programming flow of the test (intrapply) phase of operation, Phase 7. The purpose of the intrapply phase is to test the package before distribution to end users. The package is copied to an intrapply information database server at 420. The server attempts to open and load the package. If the package fails to load at 422, the Worker generates an alert at 424. If the testing of the package is successful, the Worker creates a new job message for the vendor's final phase.

FIG. 4 is a block diagram showing the programming flow of the distribution phase of operation, Phase 8. During the distribution phase the tested package is moved to a distribute directory. The Worker has completed all 8 phases with the vendor at this point. The end users' servers then poll the distribution directory at preset time intervals for the existence of new expected package. When found, the new package is downloaded, opened, and its data is loaded at 426.

The invention has been given by way of example only, and various other modifications of and/or alterations to the described embodiment may be made by persons skilled in the art without departing from the scope of the invention as specified in the appended claims.

What is claimed is:

1. A correcting data collection and warehousing system comprising:
a download interface to multiple vendor data sources for downloading data in multiple formats;
a converter interface for parsing the data in multiple formats to a predefined data format;
a data structure being updated incrementally by comparison of new data with historical data associated with the predefined data format;
a quality control interface for verifying the integrity of the data structure by applying checks directed to each of the multiple vendor data sources; and
a distribution interface to transfer data to end-users.

2. A system as recited in claim 1, wherein the download interface facilitates comparison of the vendor specific download code to the downloaded data.

3. A system as recited in claim 1, wherein the download interface comprises a timer that establishes a download time window during which can the data be downloaded from the vendor.

4. A system as recited in claim 1, wherein the converter interface comprises a predefined data row format generator.

5. A system as recited in claim 1, wherein the converter interface comprises a symbol resolver prior to generating the predefined data row format.

6. A system as recited in claim 1, wherein the data structure updates using a comparison of the new data received to the historical data stored in the data warehouse.

7. A system as recited in claim 1, wherein the system exports the processed new data to the same location as corresponding to the vendor's historical data.

8. A system as recited in claim 1, wherein the system performs packaging of a vendor's data files into a single compressed file.

9. A system as recited in claim 8, wherein the system comprises a test end user database to test the compressed file.

10. A system as recited in claim 8, wherein the distribution interface allows the end-user to retrieve the compressed file.

11. A method of populating a data warehouse with data from various vendors, wherein the data warehouse comprises a database containing historical data from various vendors, the method comprising the following operations:
downloading one or more data files from the individual vendor sources;
parsing the one or more data files received from download to a predefined data format;
deleting duplicate data;
updating that vendor's historical data if corrections are found to the predefined data format;
updating that vendor's new values as current accurate data to the predefined data format;
exporting the predefined data format to one or more data files at the location in which that vendor's historical data is located;
checking a vendor's data for incorrect values to maintain quality;
packaging the exported one or more data files into a single compressed file;
loading the single compressed file into test database system; and
storing the single compressed file in a location as to enable end user's access to retrieve.

12. A method as recited in claim 12, wherein downloading data from individual vendor sources comprises running download program to retrieve a specific vendor's files for download.

13. A method as recited in claim 12, wherein downloading data from individual vendor sources comprises a comparison between vendor specific download code and the downloaded vendor data.

14. A method as recited in claim 12, wherein downloading data from individual vendor sources comprises a comparison between time elapsed and the download time window and the job status.

15. A method as recited in claim 12, wherein parsing a new data file into the predefined data format comprises a specific vendor process program for input format parsing.

16. A method as recited in claim 12, wherein parsing a new data file into the predefined data format comprises generating a vendor symbol.

17. A method as recited in claim 12, wherein parsing a new data file into the predefined data format comprises generating and storing data into predefined rows.

18. A method as recited in claim 12, wherein deleting duplicate data comprises a comparison of new data to itself.

19. A method as recited in claim 12, wherein updating a vendor's historical data comprises a comparison of new data to old data, noting corrections as needed, and noting new data.

20. A method as recited in claim 12, wherein exporting the newly predefined data format to the location in which the vendor's historical data is located comprises creating a meta-data file with one or more data files.

21. A system for populating a data warehouse with data from various vendors, wherein the data warehouse comprises a database containing historical data from various vendors, comprising:
means for downloading one or more data files from the individual vendor sources;
means for parsing the one or more data files received from download;
means for parsing the one or more data files to a predefined data format;
deleting duplicate data;
updating that vendor's historical data if corrections are found;
means for exporting the newly formatted data file to the location in which that vendor's historical data is located;
means for checking a vendor's data for incorrect values to maintain quality;
means for packaging a vendor's exported data into a single compressed file;
means for loading the single compressed file into test database system; and
means for storing the single compressed file in a location as to enable end user's access to retrieve.
